(19) United States
(12) Patent Application Publication
(10) Pub. No.: US 2011/0063326 A1
(43) Pub. Date: Mar. 17, 2011

(54) METHOD FOR IMAGE SCALING AND SHIFTING ON A DISPLAY UNIT

(76) Inventor: Lee Fu-Wen, Hsinchu City (TW)

(21) Appl. No.: 12/559,168

(22) Filed: Sep. 14, 2009

(51) Int. Cl. G09G 5/00

(52) U.S. Cl. 345/658; 345/663

(57) ABSTRACT

A method for image scaling and shifting on a display unit comprises steps of: providing a first image to display on the display unit, in order to complete the shown on the display unit, the first image and the display unit having the same size of a length of x and a width of y; according to rotating the display unit with 90 degrees, transforming the first image with 90 degrees and scaling the first image to form a second image; the second image having a width of x and a length of x²/y; displaying a first part of the second image on the display unit; according to a shaking action, shifting a second part of the second image onto the display unit; wherein lengths of first part and the second part of the second image are x, and widths of both of them are y.

### FIELD OF THE INVENTION

The present invention is related to a display method for image scaling and shifting, particularly to a method for image rotating, scaling and shifting on a screen on an electric appliance.

### BACKGROUND OF THE INVENTION

In the prior arts, display devices are usually designed on digital cameras, mobile phones, personal digital assistants (PDA), digital photo albums or e-books. The display device on digital cameras can be used to display photos, and viewing photos. That on mobile phone can be used to display some information, and can be used to take pictures and display photos or viewing Internet pages. The high-end mobile phones can even edit documents or process image information. Personal digital assistant display devices can be used to edit files, read files, or viewing web pages online. E-book display devices can be used to read the papers. Digital photo albums can be used to play pictures.

And further, the signal for the rotation action of a display device can be detected by a G-sensor; and that can use to process the image displayed on the display device. For example, when the display device is rotated with 90 degrees, the document or image in the memory can be transformed with 90 degrees in the meantime, so that a document or an image shown on the display is comfortable to watch.

FIG. 1 shows a conventional display unit functional for auto-rotation image. That contains a mobile phone I1, a display unit 12 and an image 121. For the left part, the mobile phone 11 displays the image 121 on normal cases, and for the right part, the mobile phone 11 displays the auto-rotation image. That is, the left image 121 changes into the right image 122. Although this shows for mobile phone application schematic, but the same method can be used in digital cameras, personal digital assistants (PDAs), digital photo albums, e-books or other digital products.

The conventional auto-rotate image function has the following disadvantages:

1. Limited by the aspect ratio of display units, when the image rotates, the image must be scaled down in order to see the full image.

2. To review the image clearly, one must use buttons to zoom in or shift in order to view the important position; and if the display is a touch panel, one can easily scratch the display mirror.

Therefore, how to improve the above-mentioned shortages is the main topic in the present invention.

### SUMMARY OF THE INVENTION

An objective of the present invention is to provide a method for image scaling and shifting on a display unit. When the image on the display unit auto-rotates, the image does not need to shrink, but according to the length and width ratio, to make an appropriate amplification. The image width will be greater than the width of the display unit. To use G-sensor to detect the display unit left or right shaking, the image position can move on the display unit so as to view the video, document or photo on the display unit.

### BRIEF DESCRIPTION OF THE INVENTION

According to the present invention, a method for image scaling and shifting on a display unit comprises steps of: providing a first image to display on the display unit, in order to complete the shown on the display unit, the first image and the display unit having the same size of a length of x and a width of y; according to rotating the display unit with 90 degrees, transforming the first image with 90 degrees and scaling the first image to form a second image; the second image having a width of x and a length of x²/y; displaying a first part of the second image on the display unit; according to a shaking action, shifting a second part of the second image onto the display unit; wherein lengths of first part and the second part of the second image are x, and widths of both of them are y.

In accordance with one aspect of the present invention, a G-sensor detects the display unit for rotating and shaking.

In accordance with one aspect of the present invention, the display unit is on a mobile phone. In accordance with one aspect of the present invention, the display unit is on a digital camera.

In accordance with one aspect of the present invention, the display unit is on an e-book.

In accordance with one aspect of the present invention, the display unit is on a personal digital assistant (PDA).

In accordance with one aspect of the present invention, the display is on a digital photo album.

In accordance with one aspect of the present invention, the display unit is shaken left or right.

The present invention may best be understood through the following description with reference to the accompanying drawings, in which:

### BRIEF DESCRIPTION OF THE DRAWINGS

FIG. 1 shows the conventional method for image auto-rotation on the display unit;

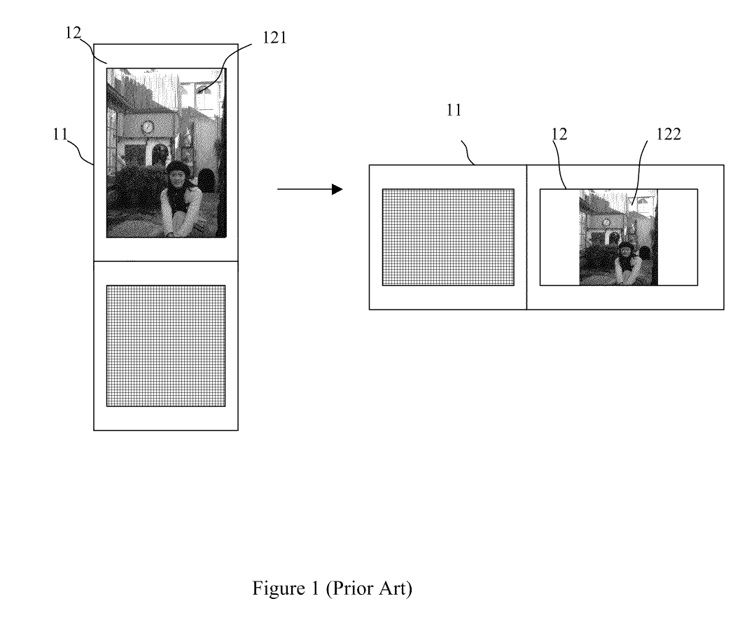

FIG. 2 shows image auto-rotation and enlargement according to the present invention;

FIG. 3 shows image shifting to left by shacking left the display unit according to the present invention; and

FIG. 4 shows image shift to right by shacking right the display unit according to the present invention.

### DETAILED DESCRIPTION OF THE PREFERRED EMBODIMENT

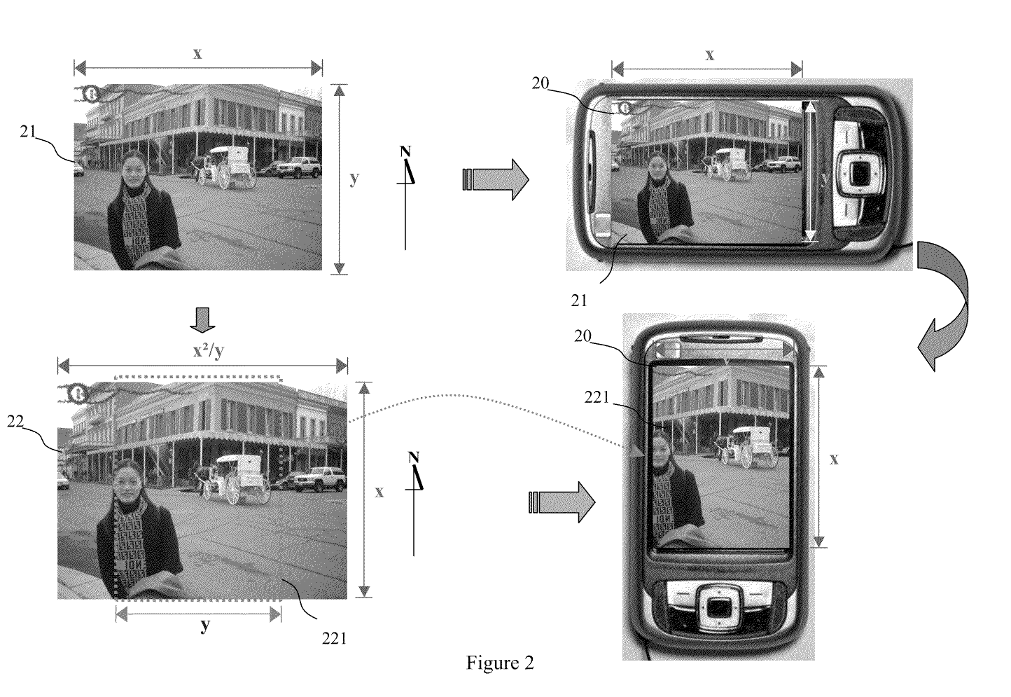

FIG. 2 shows image auto-rotation and enlargement according to the present invention. A first image 21, a second image 22, a part image 221 and a display unit 20 are included.

Normally, the display unit 20 can display the first image 21 in the normal ratio. When the display unit is rotated 90 degrees clockwise, the first image 21 will transform 90 degrees in the memory and make a proportional amplification to form a second image 22. And, the part image 221 of the second image 22 will be displayed on the display unit 20; wherein the first image has a width of y and a length of x, and the second image has a width of x and a length of x²/y, while the part image 221 of the second image 22 of the width of y and a length of x.

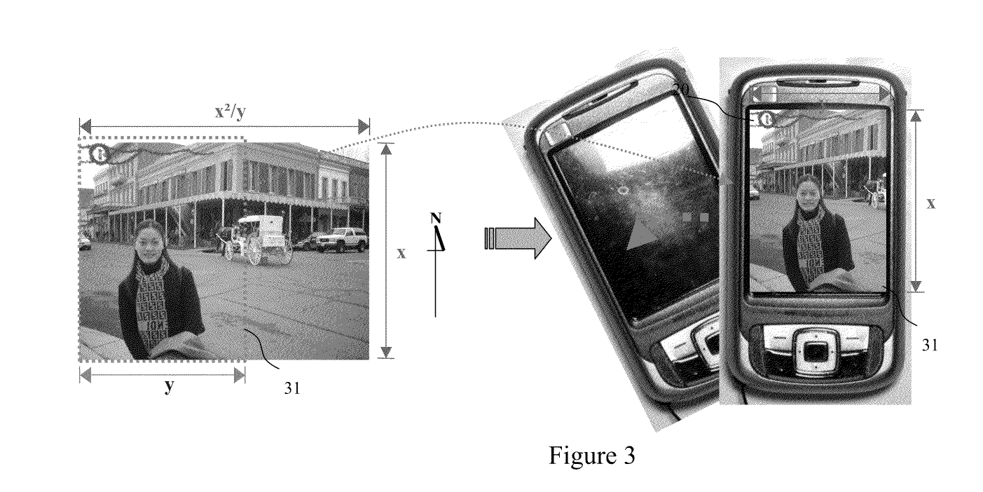

FIG. 3 shows image shifting to left by shacking left the display unit according to the present invention. When the user is leftward to view the image, he/she can shack left the display unit 20, and then the left part image 31 of the second image can be displayed in the display unit 20.

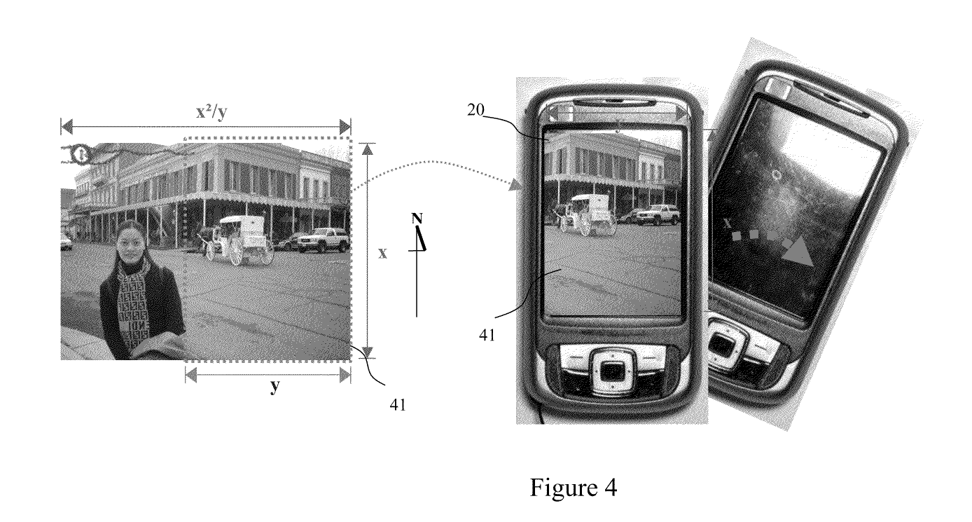

FIG. 4 shows image shift to the right by shacking right the display unit according to the present invention. When the user is rightward to view the image, he/she can shack right the display unit 20, and then the right part image 41 of the second image can be displayed in the display unit 20.

Anyway, the function in the present invention can be widely used in mobile phones, digital cameras, mp4 player, digital photo albums, e-books, or personal digital assistant (PDA), etc. For shacking to change location, the image can be demonstrated fast or slow according to the shacking strength. Certainly, the function for shaking to browse the difference location of the image, or changing to next/previous page, can use the G-Sensor to develop.

The present invention has the following advantages:

1. The present invention need not click or touch on the screen, and need not to operate buttons so that the panel of the display unit can keep clean and protect from scratches;

2. The present invention enlarges the image to a suitable ratio to make browsing more convenient.

In summary, the present invention proposes a method to scale up the image and to show the part image on the display unit. When a user wants to view or browse other part images, he/she can shack the display unit. The method in the present invention can be widely applied to different portable electronic products with the display unit while the image content can be displayed as photos, documents or web pages and other digital images.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for image scaling and shifting on a display unit, comprising steps of:
providing a first image to display on said display unit, in order to complete the shown on said display unit, said first image and said display unit having the same size of a length of x and a width of y;
according to rotating said display unit with 90 degrees, transforming said first image with 90 degrees and scaling said first image to form a second image; said second image having a width of x and a length of x²/y;
displaying a first part of said second image on said display unit;
according to a shaking action, shifting a second part of said second image onto said display unit;
wherein lengths of said first part and said second part of said second image are x, and widths of both of them are y.

2. The method according to claim 1 wherein a G sensor detects said display unit for rotating and shaking.

3. The method according to claim 1 wherein said display unit is on a mobile phone.

4. The method according to claim 1 wherein said display unit is on a digital camera.

5. The method according to claim 1 wherein said display unit is on an e-book.

6. The method according to claim 1 wherein said display unit is on a personal digital assistant (PDA).

7. The method according to claim 1 wherein said display unit is on a digital photo album.

8. The method according to claim 1 wherein said display unit is shaken left or right.
